(19) United States
(12) Patent Application Publication
(10) Pub. No.: US 2020/0025529 A1
(43) Pub. Date: Jan. 23, 2020

(54) BODY ARMOR

(71) Applicant: Jeffrey A. LISK, Brodheadsville, PA (US)

(72) Inventor: Jeffrey A. LISK, Brodheadsville, PA (US)

(21) Appl. No.: 16/398,212

(22) Filed: Apr. 29, 2019

Related U.S. Application Data
(60) Provisional application No. 62/664,008, filed on Apr. 27, 2018.

(51) Int. Cl. F41H 5/04; B32B 5/02

(52) U.S. Cl. CPC F41H 5/0478; B32B 5/024; B32B 2260/046; B32B 2260/021; B32B 2255/26; B32B 2262/0253; B32B 2571/02; B32B 2255/02

(57) ABSTRACT

Lightweight, flexible, anti-ballistic, inexpensive shielding material for body armor is described. It is created from anti-ballistic woven fabric material cut into multiple sheets of a desired shape, each having the grain of the woven material offset by 45 degrees from the adjacent sheets. The sheets are dipped into an epoxy employing carbon nanotubes. The nanotubes link to each other to result in diamond-like durability. The resulting sheets have exceptional tensile strength. A non-Newtonian shock absorbing material is adhered to the sheets, which has both liquid and solid properties. Upon impact, the local portions of the sheets are pushed into a depression and apply shear forces to the surrounding sheet and shock absorbing material, dissipating the energy over a larger area, allowing the shielding material to protect against a large ballistic impact.

### CROSS-REFERENCE TO RELATED APPLICATIONS

This application claims the benefit of U.S. Provisional Patent Application Ser. No. 62/664,008 filed Apr. 27, 2018, the disclosure of which is hereby incorporated by reference in its entirety to provide continuity of disclosure to the extent such a disclosure is not inconsistent with the current disclosure.

### STATEMENT REGARDING FEDERALLY SPONSORED RESEARCH

Not Applicable.

### BACKGROUND

### 1. Field of Invention

This invention relates to anti-ballistic shielding material and more specifically it relates to anti-ballistic shielding material incorporated into flexible body armor.

### 2. Description of Related Art

Body armor available is heavy and bulky. In order to stop large high energy projectiles, such as caliber bullets, a significant amount of material is required to absorb the energy. This typically makes them thick, heavy and bulky.

Lighter, thinner body armor using conventional materials will absorb the energy and stop smaller, less energetic projectiles. However, high energy projectiles, such as large caliber bullets from more powerful guns, will penetrate the lighter body armor and pass through it injuring the person wearing the lighter body armor.

Current body armor that can protect against larger caliber guns may use custom-made materials which are typically expensive. It would be beneficial to use conventional materials to create light-weight body armor that is effective against high-energy projectiles from large caliber guns.

Currently, there is a need for lightweight body armor which protects against large caliber firearms that is not expensive.

### BRIEF DESCRIPTION OF THE DRAWINGS

The advantages of the system described in this application will become more apparent when read with the exemplary embodiment described in the specification and shown in the drawings. Further, in the accompanying drawings and description that follow, like parts are indicated throughout the drawings and description with the same reference numerals, respectively. The figures may not be drawn to scale and the proportions of certain parts have been exaggerated for convenience of illustration.

FIGS. 1A-1C show a sequence of a ballistic projectile impacting a stationary target material.

FIG. 2A shows an energy dissipation vs. time graph of a ballistic projectile impacting a partially flexible target material.

FIG. 2B shows an energy dissipation vs. time graph of a ballistic projectile impacting a non-flexible target material.

FIG. 3 shows representative dimensions for sheets used to create a front piece.

FIG. 4 shows a plurality of sheets 111 which will be coated with the nanotube carbon epoxy in a mold to create a front piece

FIG. 5 shows body armor which can be constructed from the multi-layer molded pieces made from the sheets of FIG. 4.

FIG. 6 shows the results of testing of a sample made according to the current invention, compared to a sample constructed according to the prior art.

FIG. 7 shows a comparison of testing of three samples made according to the current invention, and two prior art shielding samples.

FIG. 8 shows a comparison of the test results of conventional samples and samples according to the current invention, both employing a non-Newtonian shock-absorbing material.

### SUMMARY

The current invention may be described as a shielding material which protects against ballistic projectiles, that has a plurality of anti-ballistic woven sheets cut into a desired shape, an epoxy having embedded carbon nanotubes covering and embedded into the sheets, and a non-Newtonian shock-absorbing material coating at least one side of the sheets.

The anti-ballistic woven sheets may be made from “Spectra” woven anti-ballistic material.

The non-Newtonian shock-absorbing material may be Sorbothane.

The anti-ballistic woven sheets have a grain and each sheets is cut to have its grain rotationally offset at least 45 degrees from any adjacent sheets.

The current invention may also be described as body armor employing at least one lightweight, flexible, anti-ballistic, inexpensive shielding piece having a plurality of acquiring an ultra-high molecular weight polyethylene (UHMWPE) woven sheets cut into a desired shape, an epoxy with carbon nanotubes covering and embedded into the plurality of sheets and a non-Newtonian shock-absorbing material coating at least one side of the sheets. It also has an upper attachment holding an upper portion of shielding piece onto a user, and a side attachments holding at least one side portion of the shielding piece to the user.

The UHMWPE woven sheets are made from “Spectra” woven anti-ballistic material.

The non-Newtonian shock-absorbing material is Sorbothane.

The upper attachment is comprised of at least one strap, and at least one side attachment is comprised of a waist band.

### DETAILED DESCRIPTION

The present invention will now be described in detail by describing various illustrative, non-limiting embodiments thereof with reference to the accompanying drawings. The invention may, however, be embodied in many different forms and should not be construed as being limited to the illustrative embodiments set forth herein. Rather, the embodiments are provided so that this disclosure will be thorough and will fully convey the concept of the invention to those skilled in the art. The claims should be consulted to ascertain the true scope of the invention.

### Theory

When a projectile, such as a bullet, travels to and impacts a shield having an outer section and inner target material, the kinetic energy of the bullet must be absorbed by the shield to stop the projectile.

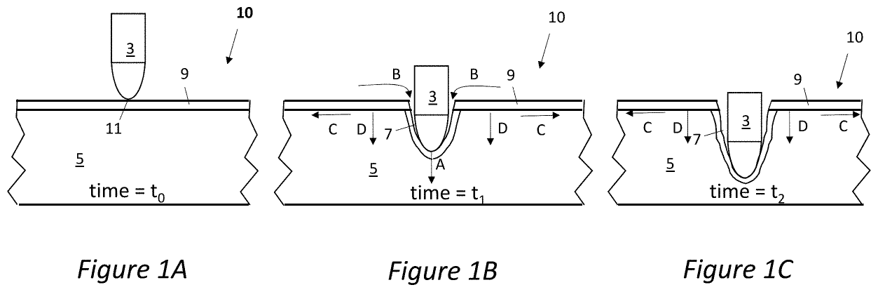

FIGS. 1A-1C show a sequence of a ballistic projectile 3 impacting a stationary shield 10. In FIG. 1A, the projectile 3 just meets the outer section 9. We refer to this as time instant to.

### Theory—Impression

In FIG. 1B, projectile 3 has pushed the outer section 9 into the underlying target material 5 which has deformed to create an impression 7. The impression 7 has a depth p₁ in the target material 5 at time ti. During the penetration, the pressing of the projectile 3 in the direction of arrow “A” into the target material 5 requires energy. The kinetic energy of the projectile 3 has been converted into mechanical energy to press an outer section 9 into target material 5 to create the impression 7. The result is a loss of kinetic energy of projectile 3, which slows the speed of projectile 3.

In FIG. 1C, all of the kinetic energy has been used, stopping the projectile 3. All kinetic energy of the projectile 3 has been converted into mechanical energy creating the impression 7 now having a depth p₂. Some of the kinetic energy is also converted into heat energy, heating the outer section 9 and target material 5 near the surface of the impression 7. No kinetic energy is left, meaning that the projectile 3 has stopped.

### Spreading the Absorption Area

One can improve the stopping (energy absorbing) ability of the target material 5 is by dissipating the energy of the projectile 3 over a larger area.

One way to do this is to have the high-tensile strength outer section 9 on the outside of the target material 5. If the tensile strength of the outer section 9 is strong enough to prevent breakage at the impact point, it pulls the outer section 9 into the impression 7. If the outer section 9 is inelastic, and has significant tensile strength, it pulls the outer section 9 inward from outlying regions.

If the outer section 9 is connected to the target material 5, then a shear force is created between the outer section 9 and the target material 5 near the impression 7, but also at areas away from the impression 7 resisting the pulling of the outer section 9 toward the impression 7. Therefore, by using a partially flexible outer section 9, the energy dissipation of the projectile 3 is extended to a larger area of the outer section. This would allow the outer section 9 and target material 5 to absorb a larger amount of energy.

Another way that energy is dissipated is due to the mushrooming effect of the projectile. At impact, the front of the projectile tends to flatten and bulge outward. This mushrooming causes the effective cross-section to become larger and create a wider radius impression 7. This causes projectile 3 to impact material making a larger radius impression 7.

In an alternative embodiment, if the outer section 9 has little flexibility, as the projectile 3 impacts the hard surface, it fractures the hardened epoxy and nanotubes, but still is caught by the woven ballistic material. This acts on the projectile 3 over a distance slowing the projectile 3. If there is still significant energy, it breaks the woven ballistic material and impacts lower shield layers.

### Impact

When a projectile, such as projectile 3 of FIG. 1A-1C, the amount of instantaneous force applied to the outer section 9 and the target material 5 is related to the amount of time it takes to stop the projectile 3.

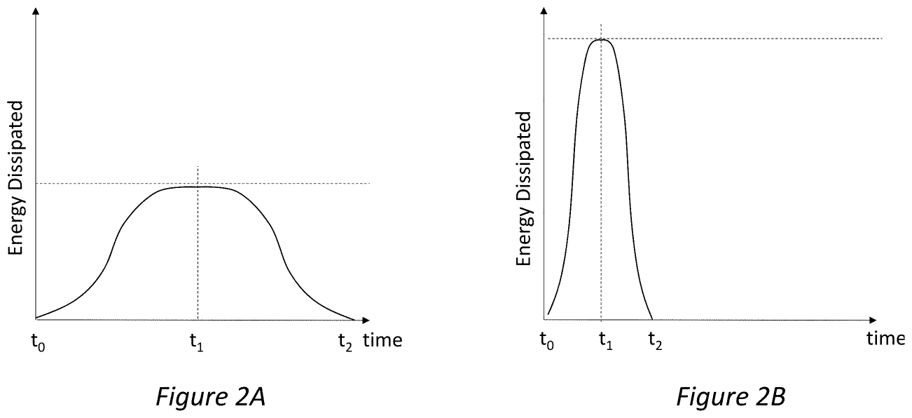

FIG. 2A shows an energy dissipation vs. time graph of a ballistic projectile impacting a partially flexible target material. The total amount of energy dissipated is the area under the curve.

FIG. 2B shows an energy dissipation vs. time graph of a ballistic projectile 3 having the same weight and speed as that of the projectile 3 of FIG. 2A, but it impacts a non-flexible outer material 9 and target material 5. The area under the curve of FIG. 2B is the same as the area under the curve of FIG. 2A. However, the instantaneous energy dissipated in much higher than that in FIG. 2A. This high energy is much more apt to break, rip or cut through the outer section 9 and the target material 5. This is contrary to the goal of protective armor.

Therefore, if one's goal is to build protective armor, it is beneficial to have a somewhat flexible outer section, with high tensile strength that dissipates energy from the projectile 3 over a period of time. This would result in thick shielding which slows the projectile 3 as it pushes an impression in the target material 5. It should also have a high tensile strength outer section 9, which is anchored to a stationary target material 5.

### Non-Newtonian Target Material

“A non-Newtonian fluid is a fluid that does not follow Newton's laws of viscosity, i.e. constant viscosity independent of stress. In non-Newtonian fluids, viscosity can change when under force to either more liquid or more solid. Ketchup for example, becomes runnier when shaken and is thus a non-Newtonian fluid. Many salt solutions and molten polymers are non-Newtonian fluids, as are many commonly found substances such as custard, honey, toothpaste, starch suspensions, corn starch, paint, blood, and shampoo”, Wikipedia.com. A Non-Newtonian fluid may be chosen for the target material 5 which would increase or decrease its viscosity when subjected to the shear force to optimize the energy absorption without allowing the projectile to pass through.

If a Non-Newtonian material is chosen that has a low viscosity when subject to the shear force, there is less resistance of the outer section 9 traveling toward the impact area 11, allowing the impression to become deeper, making the impact time longer. This will reduce the maximum instantaneous impact energy on the outer section (See FIGS. 2A, 2B), preventing rupture of the outer section 9. However, if the viscosity of the target material 5 is too low, the projectile 3 may pass through the shield 10 and injure the user wearing the shield 10.

By selecting a non-Newtonian liquid for the target material 5 which has very high viscosity, when subjected to shear forces, we may run into the situation of FIG. 2B in which the instantaneous energy is very high and blasts through the shield 10.

### Semi-Rigid Outer Section

Another way to increase the area that absorbs impact energy is to have a rigid outer section 9 that moves as a unitary object. Therefore, when impacted by the projectile 3, not only does the outer section 9 at the impact point 11 move into, and compress target material 5, but also the outer section 9 in the area surrounding impression 7 moves in the direction of arrow “D”, also compressing the target material 5. This absorbs significantly more energy than just compressing the target material 5 under the impression 7.

This aspect of energy absorption increases with the rigidity of the outer section 9. Therefore, to obtain the benefit of both the shear force of the flexible outer section 9 and the compressive force of the rigid outer section 9, a semi-flexible outer section should be used.

### Implementation

### Manufacturing Procedure

Below is one procedure to create the body armor according to the current invention.

A woven ballistic material was chosen to be used. After some research, an ultra-high molecular weight polyethylene (UHMWPE) material has the required strength properties and may be used. The UHMWPE chosen to be used was Spectra® Ballistic Material from Honeywell.

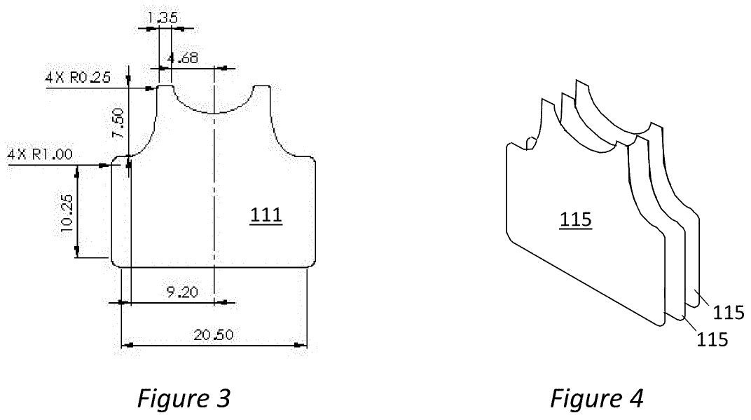

Step 1: Cut the ballistic material to desired shape making sure that the grain of each successive sheet is rotationally offset by preferably 45 degrees. FIG. 3 shows representative dimensions for sheets 111 used to create a front piece (110 of FIG. 5).

For testing purposes, several 3-inch by 3-inch and 6-inch by 6-inch squares were also cut.

Step 2: Calculate overall thickness of desired layers of material.

Example: 16 Layers of Spectra material 0.012″ (each layer)×16=0.192″ (overall thickness of Spectra.)

Step 3: Mix Carbon Nanotube epoxy resin with hardener and pour into a large pan (a 5:1 ratio is recommended by supplier of epoxy to hardener). In an alternative embodiment, a 7:1 ratio of epoxy to hardener may be used.

The change in the ratio has little to no effect on reducing the overall hardness of the body armor plate.

Step 4: Lay and submerge each sheet into mixture pan. Multiple test samples may be submerged at once for time but may not be overlapped by another test sample. The purpose is to ensure that each sheet/sample is regulated and treated equally as every other sheet/sample and eliminates other variables during the procedure.

Step 5: Calculate Carbon Nanotube adhesion to sheets 111 while submerged. Each sheet will be timed equally. The purpose is to calculate the adhesion rate of Carbon Nanotubes to the surface of our sheets, as the sheets are submerged in the epoxy for a time to ensure full coverage of our sheets.

Step 6: After the allotted time has passed, (example: 5 min.), the test sample will be carefully removed using tweezers and attached to a hang and dry line.

The above steps are repeated for the desired number of layers.

Step 7: As each layer is dripping off any excess epoxy resin back into the pan, time is recorded for each sample as it drips its last drop.

Step 8: When a layer, primarily the first test sample, has stopped dripping it will be placed in a mold of a desired shape. In an optional embodiment, it may be covered in waterproof tape. The tape is to provide a barrier that will allow our test samples to be pulled from the wooden block without affecting the integrity of our samples after fully curing for 12 or more hours. (For the samples being made, they can simply be cured on a flat surface.)

Step 9: Step 8 will be continued for each layer and the sheets will be laid upon one another but not pressed down. This process will be continued for all layers.

The layers in the mold may be pressed together during curing. They should then be allowed to cure for at least 12 hours in a vented and temperature-controlled environment.

Once the layered structure has cured, it may be assembled into body armor, or used for testing purposes.

### Body Armor

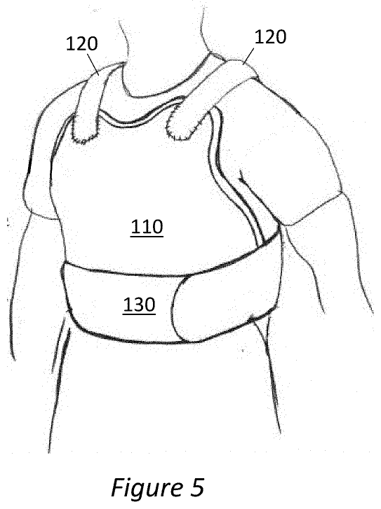

FIG. 4 shows a plurality of woven ballistic material 111 which have been coated with the nanotube carbon epoxy to create shield layers 115. These are placed together and pressed into a mold to create a front piece (110 of FIG. 5).

FIG. 5 shows body armor which can be constructed from the multi-layer molded pieces described above. For example, if using a properly shaped mold, a front piece 110 can be created.

In an optional embodiment, the inside of the multilayer molded pieces could be coated on the inside with a shock absorber and vibration damper material used as the target material. After some research, a synthetic viscoelastic urethane polymer was chosen named Sorbothane® from Sorbothane, Inc., based in Kent, Ohio. This is a non-Newtonian fluid.

Using a differently-shaped mold, a back piece may be created which generally follows the contours of the user. These may be held together with shoulder straps 120 that can be generally any fabric. A hook and loop attachment may be used to hold them together.

A wide waist band 130 may be used to hold the bottom of the front piece 110 and the rear piece together.

### Testing

The layered squares may then be tested.

### Test Set Up

6 inch by 6-inch samples were constructed in the same manner as the shield of the body armor.

Testing was performed according to the National Institute of Justice (NIJ) standards. Safety protocols were followed.

The distance from the end of the muzzle to the front of the armor sample was 15 ft.

Testing was performed using CCI Luger 9 mm rounds, which have a nominal velocity of approximately 1090 ft/s.

Table 1 below shows the test information.

TABLE 1
First Physical Test

| Layers | 20 | 26 | 32 |
|---|---|---|---|
| Average Thickness (in) | 0.287 | 0.364 | 0.443 |
| Back Face Deformation (mm) | Fail | 42.4 | 1.88 |
| Sorbothane ® (in) | 0.5 | 0.25 | 0.25 |
| Curing weight (lbs.) | 25 | 10 | 15 |
| Round Used | 9 mm FMJ | 9 mm FMJ | 9 mm FMJ |
| Weight (grains) | 124 | 124 | 124 |
| Gun Used | Ruger | Ruger | Ruger |
| | American | American | American |
| Muzzle to Target Distance (ft) | 15 | 15 | 15 |
| Average Velocity (ft/sec) | 1090 ± 25 | 1090 ± 25 | 1090 ± 25 |
| Energy (J) ± 14 | 327 | 327 | 327 |

### Second Physical Test

The test was performed again with 32-layer samples and the test information and results are shown in Table 2 below.

TABLE 2

| Layers | 32 (Three Shots) | | |
|---|---|---|---|
| Average Thickness n(in) | 0.429 | 0.429 | 0.429 |
| Back Face Deformation (mm) | 13.39 | 8 | 3.08 |
| Sorboothane ® (in) | No | 0.25 | 0.5 |
| Curing weight (grams) | 50 | 50 | 50 |
| Round Used | 9 mm FMJ | 9 mm FMJ | 9 mm FMJ |
| Weight (grams) | 124 | 124 | 124 |
| Gun Used | Ruger | Ruger | Ruger |
| | American | American | American |
| Muzzle to Target Distance (ft) | 15 | 15 | 15 |
| Average Velocity (ft/sec) | 1090 +/− 25 | 1090 +/− 25 | 1090 +/− 25 |
| Energy (J) =/− 14 | 327 | 327 | 327 |
| Material | Hopton | Hopton | Hopton |
| | Body | Body | Body |
| | Armor | Armor | Armor |
| Soft | No | No | No |
| Muzzle Length (in) | 4 | 4 | 4 |
| Decrease in Depth % | | 40 Percent | 77 Percent |

### Comparison to Prior Art Products

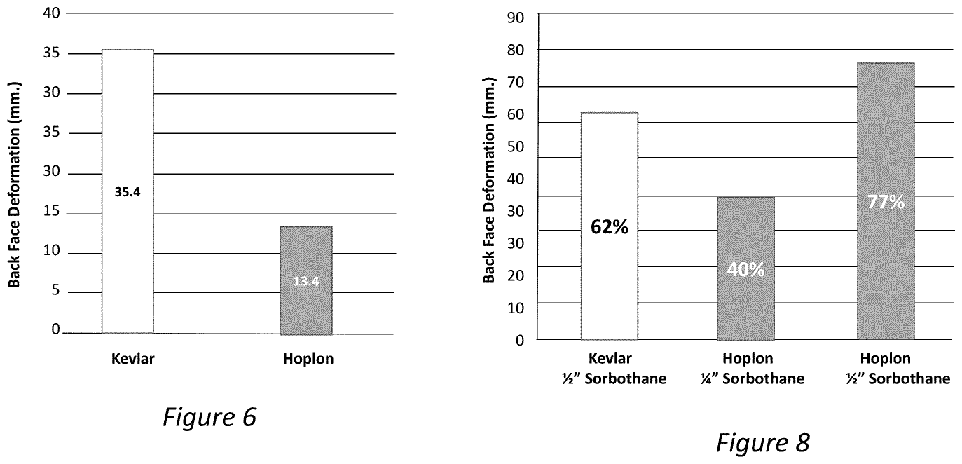

FIG. 6 shows the results of testing of a sample made with the woven sheets and carbon fiber nanotube epoxy, as per the current invention that is referred to as “Hoplon”, against a sample made with prior art Kevlar® shielding material. This is a standard Roma Ballistic Clay Deformation graph measuring deformation in millimeters of the back face of each sample. The samples were created with the same procedure but using different materials.

The first bar to the left represents the backside deformation of the back face of Kevlar without any Sorbothane. The bar at the right represents deformation of the back face of the Hoplon sample without any Sorbothane. It was shown here that the sample according to an embodiment of the current invention had 62% less deformation as compared with Kevlar®.

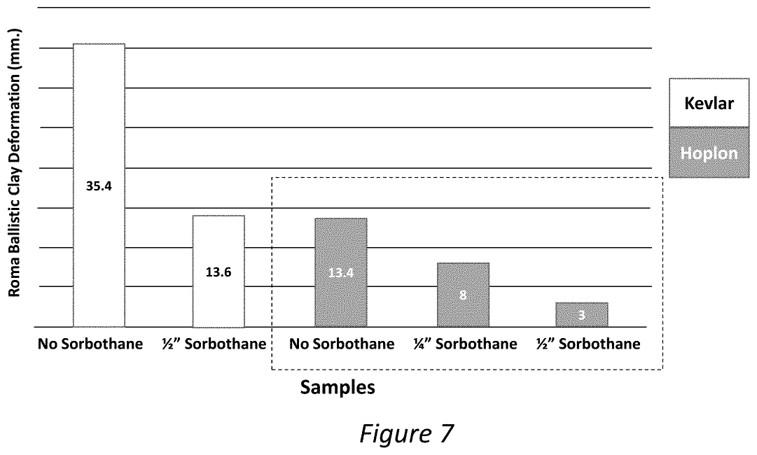

FIG. 7 shows the results of testing of three samples made according to the current invention, and two prior art shielding samples made with Kevlar®. This is also a standard Roma Ballistic Clay Deformation graph showing deformation on the back face in millimeters of several samples created with the same procedure but using different materials.

The first bar to the left relates to a sample constructed of Kevlar only. It had a back face deformation of 35.4 mm.

The second bar from the left relates to a sample constructed of Kevlar and ½ inch thick Sorbothane. It had a back face deformation of 13.6 mm. This is a significant improvement.

The center bar relates to a sample constructed with Spectra® sheets and carbon nanotube epoxy. It had a back face deformation of 13.4 mm.

The second bar from the right relates to a sample constructed with Spectra® sheets, carbon nanotube epoxy, and ¼ inch thick Sorbothane being an embodiment of the current invention. It had a back face deformation of 8 mm.

The last bar from the right relates to a sample constructed with Spectra® sheets, carbon nanotube epoxy, and ½ inch thick Sorbothane, being another embodiment of the current invention. It had a back face deformation of 3 mm.

This indicates that ballistic shielding constructed with the Spectra® sheets, carbon nanotube epoxy and Sorbothane have lower deformation at the back face than those using Kevlar.

The bars within the dashed line indicate results relating to use of the Spectra sheets with carbon nanotube epoxy.

This also indicates that ballistic shielding constructed with the Spectra® sheets, carbon nanotube epoxy and Sorbothane have lower deformation at the back face than those without Sorbothane.

FIG. 8 shows a comparison of the back face deformation test results of conventional Kevlar® samples and samples according to the current invention (Hoplon samples) both employing a non-Newtonian shock-absorbing material, Sorbothane®. The bar on the left is Kevlar used with ½ inch Sorbothane attached to it. The addition of Sorbothane to the Kevlar reduces deformation of the same by 62%.

The center bar shows the decrease in deformation when Hoplon was used with ¼ inch thick Sorbothane. This results in a decrease in deformation of 40%.

The right bar shows the decrease in deformation when Sorbothane is used with Hoplon. Hoplon, when combined with Sorbothane reduces the amount of deformation by more than 76%.

Hoplon Body Armor has been tested in compliance to NIJ standards-0101.06. Our 5″×5″ samples were tested to protect against:
Type IIa armor with 9 mm Full Metal Jacketed Round Nose (FMJ RN) bullets with a specified mass of 8.0 g (124 gr) and a velocity of (1225 ft/s±30 ft/s); and
Type II armor with 0.357 Magnum Jacketed Soft Point (JSP) bullets with a specified mass of 10.2 g (158 gr) and a velocity of (1430 ft/s±30 ft/s).

Each sample was shot 3 times. Stopping all bullets while minimizing the impact onto the back-face signature by more than 44% when compared to existing vests.

While the present disclosure illustrates various aspects of the present teachings, and while these aspects have been described in some detail, it is not the intention of the applicant to restrict or in any way limit the scope of the claimed systems and methods to such detail. Additional advantages and modifications will readily appear to those skilled in the art. Therefore, the teachings of the present application, in its broader aspects, are not limited to the specific details and illustrative examples shown and described. Accordingly, departures may be made from such details without departing from the spirit or scope of the teachings of the present application. Moreover, the foregoing aspects are illustrative, and no single feature or element essential to all possible combinations may be claimed in this or a later application.

What is claimed is:

1. A shielding material which protects against ballistic projectiles, comprising:
a. a plurality of anti-ballistic woven sheets cut into a desired shape;
b. an epoxy having embedded carbon nanotubes covering and embedded into the sheets;
c. a non-Newtonian shock-absorbing material coating at least one side of the sheets.

2. The shielding material of claim 1, wherein the anti-ballistic woven sheets are made from “Spectra” woven anti-ballistic material.

3. The shielding material of claim 1, wherein the non-Newtonian shock-absorbing material is Sorbothane.

4. The shielding material of claim 1, wherein:
a. the anti-ballistic woven sheets have a grain; and
b. each sheets is cut to have its grain rotationally offset at least 45 degrees from any adjacent sheets.

5. A method of creating anti-ballistic shielding comprising the steps of:
a. acquiring an ultra-high molecular weight polyethylene (UHMWPE) woven material;
b. cutting the UHMWPE material into a plurality of sheets 111 of a desired shape, making sure to have a grain of each sheet to be rotationally offset from sheets before and after it by at least 45 degrees;
c. immersing the sheets in a carbon nanotube epoxy until saturated to create a shield layer 115;
d. pressing the shield layers together as they cure to create a piece of multilayered anti-ballistic shielding.

6. The method of claim 5, wherein the UHMWPE is Spectrum woven material.

7. The method of claim 5, further comprising:
non-Newtonian shock-absorbing material attached to the inside of the anti-ballistic shielding.

8. The method of claim 5, wherein the non-Newtonian shock-absorbing material is Sorbothane.

9. The method of claim 5, wherein the piece of multilayered anti-ballistic shielding is incorporated into wearable body armor.

10. Body armor comprising:
a. at least one lightweight, flexible, anti-ballistic, inexpensive shielding piece comprising:
I. a plurality of acquiring an ultra-high molecular weight polyethylene (UHMWPE) woven sheets cut into a desired shape;
II. an epoxy with carbon nanotubes covering and embedded into the plurality of sheets;
III. a non-Newtonian shock-absorbing material coating at least one side of the sheets;
b. upper attachments holding an upper portion of shielding piece onto a user;
c. side attachments holding at least one side portion of the shielding piece to the user.

11. The body armor of claim 10, wherein the UHMWPE) woven sheets are made from “Spectra” woven anti-ballistic material.

12. The body armor of claim 10, wherein the non-Newtonian shock-absorbing material is Sorbothane.

13. The body armor of claim 10, wherein upper attachment is comprised of at least one strap.

14. The body armor of claim 10, wherein at least one side attachment is comprised of a waist band.
